(19) United States
(12) Patent Application Publication
(10) Pub. No.: US 2019/0112720 A1
(43) Pub. Date: Apr. 18, 2019

(54) PULSED CURRENT CATALYZED GAS DIFFUSION ELECTRODES FOR HIGH RATE, EFFICIENT CO2 CONVERSION REACTORS

(71) Applicant: Faraday Technology, Inc., Englewood, OH (US)

(72) Inventors: Brian T. Skinn, Union, OH (US); Timothy D. Hall, Englewood, OH (US); E. Jennings Taylor, Troy, OH (US)

(21) Appl. No.: 16/141,071

(22) Filed: Sep. 25, 2018

Related U.S. Application Data
(60) Provisional application No. 62/571,375, filed on Oct. 12, 2017.

(51) Int. Cl. C25B 3/04; H01M 4/86; H01M 4/88; H01M 4/96; B01D 53/86

(52) U.S. Cl. CPC C25B 3/04; H01M 4/8605; B01D 2255/2094; H01M 4/96; B01D 53/8671; H01M 4/8807

(57) ABSTRACT

An electro catalytic CO₂ reduction method including forming a gas diffusion cathode including a porous layer and gas diffusion layer. The method includes electrocatalyzing the gas diffusion cathode by electrochemically depositing a CO₂ reduction catalyst using a pulse current or pulse reverse current passed between the gas diffusion cathode and a counter electrode in a bath containing ions of the catalyst to balance nucleation/growth of the catalyst particles resulting in a more uniform deposition of catalyst particles of predominantly less than 20 nm. The electro catalyzed gas diffusion cathode is utilized in an electrochemical reactor along with an anode and voltage source connected to the cathode and anode to convert CO₂ to another chemical (e.g., formic acid).

### RELATED APPLICATIONS

This application claims benefit of and priority to U.S. Provisional Application Ser. No. 62/571,375 filed Oct. 12, 2017, under 35 U.S.C. §§ 119, 120, 363, 365, and 37 C.F.R. § 1.55 and § 1.78, which is incorporated herein by this reference.

### GOVERNMENT RIGHTS

This invention was made with U.S. Government support under Small Business Innovation Research Contract No. DE-SC0015173 awarded by the United States Department of Energy. The Government may have certain rights in the subject invention.

### FIELD OF THE INVENTION

The present invention relates to a process to apply highly active electrocatalyst particles to a gas diffusion electrode for efficient electroreduction of CO₂ to useful materials like formic acid.

### BACKGROUND OF THE INVENTION

Since the 1870's, there have been many attempts to find efficient approaches to reduce CO₂ to organic compounds due to the industrial need for a carbon source and the large amounts of CO₂ generated by human activities. See Jitaru, M., J. Appl. Electrochem. 27 (1997) 875 incorporated herein by this reference. Procedures have been developed using radiochemical, chemical, thermochemical, photochemical, electrochemical, and biochemical techniques to accomplish this goal. See Yuan, Z., M. R. Eden. Ind Eng Chem Res 55(12): 3383 (2016) incorporated herein by this reference.

However, a recent DOE report indicates that major scientific challenges still exist to realize the following: 1) development of an efficient, inexpensive, and durable catalytic system, 2) establishing design principles to facilitate complex, multi-electron and atom/ion transfer events, and 3) understanding the free energy landscape for these coupled thermal and non-thermal reactions. See Basic Research Needs: Catalysis for Energy, 8/6-8/2007. www.sc.doe.gov/bes/reports/list.html incorporated herein by this reference.

Modern carbon emission mitigation efforts in the interim have focused on carbon capture and sequestration (CCS). See Carbon Dioxide Capture and Sequestration. http://www3.epa.gov/climatechange/ccs/ incorporated herein by this reference. Despite the remaining challenges in developing CO₂ conversion technologies, the need is clear that to reduce risk and offset the cost of CCS, development of CO₂ utilization/conversion technologies to generate value-added products will be required.

Electrocatalytic reduction is a promising approach for CO₂ conversion and can be achieved on various cathode materials. Depending on the electrocatalyst, CO₂ can be selectively reduced to a variety of materials including CO, hydrocarbons (methane, ethylene), alcohols (methanol, ethanol), aldehydes, or carboxylic acids (formic, oxalic acids). See Chaplin, R. P. S., Wragg, A. A.; J. Appl. Electrochem. (2003), 33, 1107 and Azuma, M., J. Electrochem. Soc., (1990), 137, 1772 both incorporated herein by this reference. One product receiving increased interest is formic acid due to its range of commercial applications, liquid state, favorable product-to-electron ratio (one mole of formic acid requires only two moles of electrons, versus ethylene or ethanol requiring twelve electrons/mol) and high conversion efficiency. See Yano, J., Yamaskai, S.; J. Appl. Electrochem. (2008) 37, 255 and Sumbramanian, K.; J. Appl. Electrochem. (2007), 37, 255 both incorporated herein by this reference. Furthermore, formic acid is a product from CO₂ reduction likely to yield favorable economics. The potential profitability of reducing CO₂ (carbon credit price of $20 ton⁻¹) (see 2015 CO₂ Price Forecast. http://www.synapse-energy/sites/default/files/2015%20Carbon%20Dioxide%20Price%20Report.pdf incorporated herein by this reference) to formic acid (current price of $400 ton⁻¹) (see “Minimum price for 85-90% formic acid.” http://www.alibaba.com/showroom/market-price-formic-acid.html 10/16/15 incorporated herein by this reference) has been demonstrated by DNV; however the sustainable economics of such a process requires the development of efficient, selective processing conditions. See Sridhar, N., D. Hill, A. Agarwal, Y. Zhai, E. Hektor. “Carbon Dioxide Utilization. Electrochemical Conversion of CO₂-Opportunities and Challenges.” DNV (2011) incorporated herein by this reference.

A number of materials have shown selective reduction of CO₂ to formic acid including Pb, Hg, In, Sn, Cd, and Tl. See Koleli, F., et al.; J. Appl. Electrochem. (2003) 33, 447 incorporated herein by this reference. Sn is the most attractive as the others are toxic, expensive, or both. While Hori found tin foil has a ˜88% faradaic efficiency for CO₂ to formic acid, (see Y. Hori, H. Wakebe, T. Tsukamoto, O. Koga. Electrochim Acta 39: 1833 (1994) incorporated herein by this reference), literature values range from 0.3-95.0%, depending on catalyst structure and morphology as well as electrolysis conditions. See Y. Hori, H. Wakebe, T. Tsukamoto, O. Koga. Electrochim Acta 39: 1833 (1994); Azuma M, K Hashimoto, M Hiramoto, M Watanabe, T Sakata J Electrochem Soc 137 1772, 1990, Agarwal, A. S.; Y. Zhai, D. Hill, N. Sridhar. ChemSusChem 4: 1301 (2011); Chen, Y., M. W. Kanan. J Am Chem Soc 134: 1986 (2012); Wu, J., F. Risalvato, F. S. Ke, P. Pellechia, X. Zhou. J Electrochem Soc 159: F353 (2012; Zhang, S., P. Kang, T. J. Meyer. J Am Chem Soc 136: 1734 (2014); Wu, J., F. G. Risalvato, S. Ma, X.-D. Zhou. J Mater Chem A 2: 1647 (2014); Lv, W., R. Zhang, P. Gao, L. Lei. J Power Sources 253: 276 (2014); Kim, H.-Y., et al, Int J Hydrogen Energy 39: 16506 (2014); Lee, S., J. D. Ocon, Y.-I. Son, J. Lee. J Phys Chem C 119: 4884 (2015); Wang, Q., H. Dong, H. Yu, H. Yu. J Power Sources 279: 1 (2015); Zhang, R., W. Lv, G. Li, L. Lei. Mater Lett 141: 63 (2015); Baruch, M. F., J. E. Pander, J. L. White, A. B. Bocarsly. ACS Catal 5: 3148 (2015); Lee, S., et al. J Mater Chem A 3: 3029 (2015); Prakash, G. K. S., F. A. Viva, G. A. Olah. J Power Sources 223: 68 (2013); and Wang, Q., H. Dong, H. Yu. J Power Sources 271: 278 (2014) all incorporated herein by this reference.

The most promising results have been obtained on nanostructured Sn catalysts with reduced native oxide layers; newer work is investigating electrocatalysis on tin oxide surfaces. See Fu, Y., Y. Li, X. Zhang, Y. Liu, J. Qiao, J. Zhang, D. Wilkinson. Appl. Energy 175: 536 (2016) and Kopljar, D., N. Wagner, E. Klemm. Chem Eng Technol 39(11): 2042 (2016) both incorporated herein by this reference. Zhang (see Zhang, S., P. Kang, T. J. Meyer. J Am Chem Soc 136: 1734 (2014) incorporated herein by this reference) showed maximum efficiency of >93% on reduced nanoscale tin oxide catalyst surfaces with particle sizes ˜5 nm. Won studied electrodeposited dendritic tin and proposed that native subsurface oxide remains, even under highly reducing conditions, and plays an important role in stabilizing the intermediate radical anion CO₂. See Won, D. H., C. H. Choi, J. Chung, M. Chugn, E. Kim, S. Woo. ChemSusChem 8(18): 3092 (2015) incorporated herein by this reference. The exact role of the oxide layer remains unclear as a number of other factors may influence observed performance efficiencies (e.g., catalyst surface area, film thickness).

### BRIEF SUMMARY OF THE INVENTION

One challenge is development of CO₂ electrochemical conversion process that enable high currents per geometric electrode area (current density), high product yields versus undesirable side-products and low power consumption per quantity of product. Gas diffusion electrodes (GDEs) containing the appropriate electrocatalyst are an attractive approach to CO₂ electrochemical reduction at high current densities, high product yield and low power consumption. Although this invention is not bound by any theory, the principles of operation of a GDE are considered to be fairly well understood and generally relevant to the principles of this invention. One aspect of any GDE is its ability to provide a complicated interface between a gaseous reactant, a heterogeneous electrocatalyst and an electrolyte containing the appropriate ions. Two different kinds of electrical pathways must be provided to this three-way interface, an ionic pathway through the electrolyte and an electronic pathway through an electrically conductive material. More specifically, a Sn electrocatalyst with high specific surface is incorporated in a GDE to provide the desired three-phase interface between the gaseous CO₂ reactant, the high surface area Sn electrocatalyst and the ion containing electrolyte. Therefore, this process enables fabrication of high surface area Sn electro catalyst layers with polymer electrolyte inclusions into GDEs by electrodeposition to serve as high performance cathodes within flow reactors for CO₂ electrochemical reduction.

The amount of scientific and patent literature which describes the typical GDE is vast. By way of a brief summary, most of these known GDE structures contain a hydrophobic polymer obtained by fluorinating a hydrocarbon polymer or by polymerizing an unsaturated, partially or fully fluorinated monomer (tetrafluoroethylene, hexafluoropropene, trifluorochloroethylene, less preferably vinylidene fluoride, etc.) and a particulate and/or fibrous, relatively inexpensive electrically conductive material which may or may not be pressed and/or sintered. The preferred electrically conductive material is usually carbon, which may if desired be present in two forms: as a fibrous sheet or cloth backing material for structural integrity referred to as the carbon fiber substrate (CFS) and as a very finely divided mass of particles which provides the support for a highly active electrocatalyst referred to as the microporous layer (MPL).

In the typical conventional GDE structure, the concentration of hydrophobic polymer in the structure increases to a very high level at one face and drops off to a relatively low level at the opposite face. The face provided with the higher level of hydrophobic polymer is permeable to gases, but the hydrophobic polymer protects against flooding of the GDE by a liquid electrolyte. Accordingly, the face with the high concentration of hydrophobic polymer is the gas-permeable (hydrophobic) CFS face which has direct access to the flow of gaseous CO₂ reactant. This hydrophobic face is sometimes referred to as the “gas” side of the electrode. On the opposite face, where the amount of hydrophobic polymer is relatively low, the amount of finely divided catalyst support material is very high. This opposite face can be referred to as the “catalytic” MPL face. A greatly magnified cross-section of this typical GDE structure would reveal a fibrous mat protected with hydrophobic polymer on the “gas” CFS side and a mass of tiny support particles on the “catalytic” MPL side. Generally, the CFS layer is mostly hydrophobic and the MPL layer has a mixed hydrophobic/hydrophilic character. The mostly hydrophobic character of the CFS is important to 1) permit penetration of the CO₂ gaseous reactant into the MPL, and 2) prohibit penetration of the liquid electrolyte into the CFS resulting in flooding and slow transport of the gaseous CO₂ reactant to the MPL. The mixed hydrophobic/hydrophilic character of the MPL is important to 1) avoid liquid penetration through to the carbon fiber substrate (CFS) while also 2) facilitating wetting in order to establish a three-phase interface between the gaseous CO₂ reactant AND the solid catalyst supported on the electron conducting carbon AND the electrolyte.

A variety of fibrous carbon materials (carbon cloth, carbon paper, etc.) are commercially available for use as the backing material on the hydrophobic CFS side of the GDE. The preferred hydrophobic material used in the GDE structure to effect the mostly hydrophobic CFS layer and the mixed hydrophobic/hydrophillc MPL layer are fluorinated ethylene propylene (FEP), polytetrafluoroethylene (PTFE), polytrifluorochlorethylene, and the like, FEP or PTFE and its copolymers being particularly preferred. The essentially fully fabricated but untreated GDE used as a starting material in this invention can be treated on one side with hydrophobic polymer and pressed and/or subjected to sintering temperatures prior to use in the impregnation step described subsequently. Several types of very high surface area carbon particles, both graphitized and non-graphitized are available for use as the electrocatalyst support materials used in the MPL layer. The surface area of these available support materials can range all the way from as low as 50 m.sup.2/g to more than 1000 m.sup.2/g (e.g. up to 2000 m.sup.2/g). A more typical range of surface area is 200-1200 m.sup.2/g. When the carbon support material is non-graphitized it may be more subject to corrosion or attack when the fuel cell is in use. On the other hand, non-graphitized forms of carbon are more wettable and can be easier to work with. The graphitized forms of carbon tend to be relatively resistant to attack in the presence of acidic and even basic electrolytes.

A three phase interface concept is generally described by a “flooded agglomerate” model consisting of spheres of ionomer coated catalyst particles. Due to this uniform distribution, some of the electrocatalyst particles are not in contact with the carbon particles of the MPL (electrocatalyst particles within the red circles). Similarly, some of the catalyst particles may be in contact with carbon particles of the MPL that possess no electrical continuity with the broader gas diffusion (GDL) structure due to isolation by the TEFLON® In both cases the catalyst particles are not utilized in the electrochemical reaction.

In one aspect, a method is featured in which the catalyst particles are electrochemically deposited after application of the MPL onto the CFS. In this manner, the catalyst particles are only deposited on the GDL where accessibility exists both to the proton conducting ionomer and to an electron conducting pathway to the CFS resulting in catalyst surface area with a high electrochemical activity. Pulse/pulse reverse electrodeposition electrocatalyzation is further used to balance nucleation/growth of catalyst particles resulting in more uniform catalyst particle deposition.

Aspects of the invention are directed towards electrodeposition of catalysts on a gas diffusion electrode (GDE) for efficient reduction of CO₂ to valuable products. Depending on the catalyst, for example Sn, the product may be changed. For example, Sn catalyst reduces CO₂ to formic acid. The disclosed Gas Diffusion Layer (GDL) includes a Carbon Fiber Substrate (CFS) with a second a High Surface Area (HSA) Carbon Microporous Layer (MPL). In conventional practice, the HSA is catalyzed prior to application of the MPL onto the CFS. In one preferred method, the electrocatalyst particles are electrodeposited after the application of the MPL onto the CFS. The result is an improvement in performance and selectivity resulting from electrodeposition of the CO₂ reduction catalyst and the electrodeposition is pulse current or pulse reverse current (PC/PRC) in contrast to Direct Current (DC).

The present invention relates to designing electro catalytic systems that enable the efficient reduction of CO₂ by utilizing gas diffusion electrode (GDE) based electrochemical technology. Specifically, the invention enables: 1) uniform, adherent nanoparticles that are applied directly to MPL substrates by electrodeposition, 2) enhanced current density and formate selectivity when electrochemically reducing CO₂, and 3) inherent commercialability and scalability.

The subject invention, however, in other embodiments, need not achieve all these objectives and the claims hereof should not be limited to structures or methods capable of achieving these objectives.

### SUMMARY OF THE INVENTION

Featured is an electrocatalytic CO₂ reduction method comprising forming a gas diffusion cathode including a high surface area largely microporous layer on a low surface area gas diffusion layer. The microporous layer is preferably relatively hydrophilic compared to the relatively hydrophobic gas diffusion layer. The process then includes electrocatalyzing the gas diffusion cathode by electrochemically depositing a CO₂ reduction catalyst onto the microporous layer using a pulse current or pulse reverse current passed between the gas diffusion cathode and a counter electrode in a bath containing ions of the catalyst to balance nucleation/growth of the catalyst particles resulting in a more uniform deposition of catalyst particles of predominantly less than 20 nm onto the microporous layer. Next, the electrocatalyzed gas diffusion cathode is employed in an electrochemical reactor along with an anode and voltage source connected to the cathode and anode to convert CO₂ to another chemical.

The reduction catalyst is preferably selected from the group including Pb, Hg, In, Sn, Cd, and Ti. In the electrocatalytic CO₂ reduction method, formic acid may be produced. One preferred reduction catalyst is Sn. In some examples, the low surface area gas diffusion layer is carbon paper the high surface area largely microporous layer includes conductive particles in a resin binder.

Also featured is a method of making a gas diffusion cathode. A microporous layer is applied to a macroporous layer to form a cathode. The cathode is subjected to an electrocatalyzation process including electrochemically depositing a reduction catalyst onto the microporous layer. As a result, catalyst particles are in contact with particles of the microporous layer which are in electrical continuity with the macroporous layer.

The macroporous layer is hydrophobic and the microporous layer is partially hydrophobic and partially hydrophilic. The macroporous layer may include carbon fiber substrate and the microporous layer may include high surface area conductive particles with a resin binder.

Also featured is a method of making a gas diffusion cathode. A high surface area carbon microporous layer is applied to a macroporous carbon fiber substrate. The high surface area carbon microporous layer is subjected to an electrocatalyzation process including electrochemically depositing, using a pulse current or pulse reverse current, catalyst particles onto the carbon particles of the carbon microporous layer and providing a proton conducting ionomer partially penetrating the carbon particles of the carbon microporous layer. A preferred electrocatalyzation process includes placing the gas diffusion cathode in a bath including ions of the catalyst and connecting a power supply to the carbon fiber substrate and a counter electrode in the bath with the microporous layer facing the electrolyte such that the nano-crystalline electrocatalyst particles are electrodeposited into the microporous layer.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a generalized pulse reverse waveform for electrochemical deposition;

FIG. 2 is a comparison of current densities and formate faradaic efficiencies obtained in accordance with the invention and as compared to prior art processes.

FIG. 3 is a plot of total cell voltage and current density obtained using the flow reactor in a three electrode configuration using a baseline Sn-150 GDE cathode and Pt/H₂ counter-electrode;

FIG. 4 is a plot of total cell voltage and formate faradaic efficiency obtained using the flow reactor in the two electrode configuration under galvanostatic control; conventional Sn-150 GDE cathode and Pt/H₂ counter electrode;

FIG. 5 is a plot of total cell voltage at various applied currents over the course of an hour long electrolysis in the flow reactor; two-electrode configuration using a conventional Sn-150 GDE cathode and Pt/H₂ counter electrode;

FIG. 6 is a side view of an example of a gas diffusion cathode in accordance with an example of the invention;

FIG. 7 is a schematic view of an electrochemical deposition cell in accordance with an example of the invention;

FIG. 8 is a view of the cathode of FIG. 7 after electrocatalyzation;

FIG. 9A is a view of a cathode structure according to the prior art methods such as spray-coating;

FIG. 9B is a view of the cathode structure when electrocatalyzation is used; and

FIG. 10 is a schematic view of an electrochemical reactor in accordance with an example of the invention.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

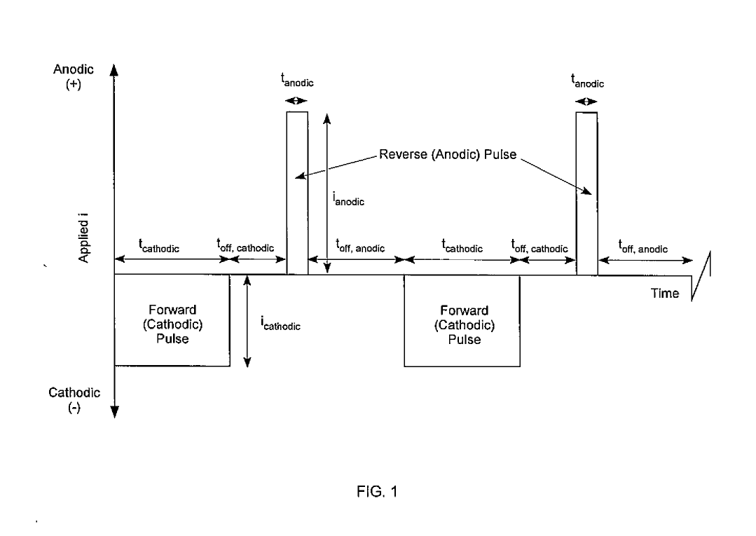

Featured is an electrodeposition based process to fabricate high-performance tin GDE electrocatalysts for the CO₂ conversion to formate. A pulse/pulse reverse electric field, is preferably used as shown in FIG. 1 to improve electrocatalyst availability and activity. The waveform consists of a cathodic (forward) pulse followed by a first relaxation period (off-time) and an anodic (reverse) pulse and a second relaxation period (off-time). The cathodic peak current, cathodic on-time, anodic peak current, anodic on-time, the first relaxation-time and the second relaxation-time are individual variables for process control. In some cases only the first or second relaxation-time may be required. In other cases, no relaxation time may be required. In still other cases only the cathodic pulse and relaxation-time may be required. The initial data was evaluated based upon (1) the capability to deposit uniform, adherent tin particles on commercial GDE substrates; (2) the electrochemical performance (total current density, formate selectivity) of the electrodeposited GDEs in representative electroreactor hardware; and (3) scalability and economic feasibility of the GDE electrocatalysts on the scale of industrial electrical generation.

The present invention will be illustrated by the following example, which is intended to be illustrative and not limiting but could be embodiments of the process.

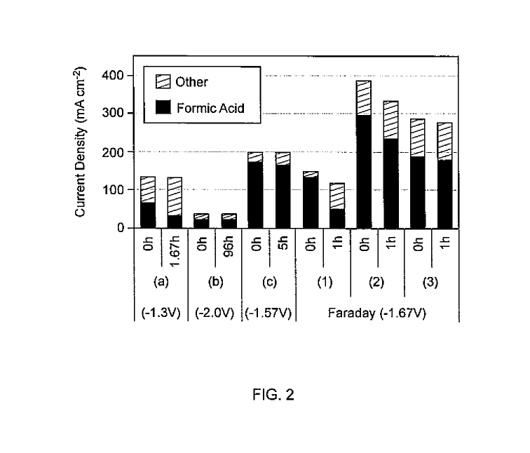

FIG. 2 shows measured current densities and formate selectivities for the GDEs prepared in the present study as well as selected literature values. See D. Kopljar, N. Wagner, E. Klemm. Chem Eng Technol 39(11): 2042 (2016) and H. Li, C. Oloman. J Appl Electrochem 35(10): 955 (2005) both incorporated herein by this reference. For both electrocatalyzed samples a higher absolute and partial formate current density was observed as compared both to the baseline (Sn-150) GDEs and to notable prior reports that utilized a GDL-type electrode and electrolytes of comparable ionic strengths. This is indicative of a “break-in” period where the current response of the GDE stabilizes until it attains a stable average value, consistent with previous literature reports of similar GDE type electrodes. See D. Kopljgar, A. Inan, P. Vindayer, N. Wagner, E. Klemm. “Electrochemical reduction of CO2 to formate at high current density using gas diffusion electrodes.” J Appl Electrochem 44(10): 1107 (2014) and E. Irtem, T. Andreu, A. Parra, M. D. Hernandez-Alonso, S. Garcia-Rodriguez, J. M. Riesco-Garcia, G. Penelas-Perez, J. R. Morante. J Mater Chem A 4: 13582 (2016) both incorporated herein by this reference. Electrolyte leakage was observed with several of the electrocatalyzed samples; the leaked electrolyte was collected and accounted for in all efficiency calculations. This flooding/leakage issue was largely absent in electrocatalyzed samples prepared from Triton-free plating electrolyte; however, these samples showed considerably poorer electrocatalytic performance. Thus, the composition of the deposition bath should be optimized to achieve a desirable balance of properties in the finished GDE. It is possible, for example, that the use of a lower Triton concentration in the plating bath in tandem with a higher ionomer MPL loading may provide optimal MPL (and thus catalyst) wetting while preventing electrolyte penetration into the CFS layer of the GDL.

Durability of the GDEs was assessed by performing duplicate electrolysis tests. The setup was rinsed with deionized water between trials, which may or may not have had an effect on the above-mentioned delamination of the catalyst from the GDL. The change in current density and faradaic efficiency observed for various samples over two electrolysis trials conducted on the same electrode, expressed as a percent change from the original value was determined. The two electrocatalyzed GDEs that exhibited the highest current densities observed (Sn-013 and Sn-014, at 388 and 328 mA cm⁻², respectively) both showed modest decreases in current density and formic acid efficiency in the repeated run, as compared to recent literature reports. However, sample Sn-016 exhibited a minimal decrease in both metrics over the course of the two trials, in line with the previous reports. The primary difference between samples Sn-013/-014 and Sn-016 is a modestly greater ionomer loading. Hence, again, optimization of the GDL pretreatment/conditioning may be required.

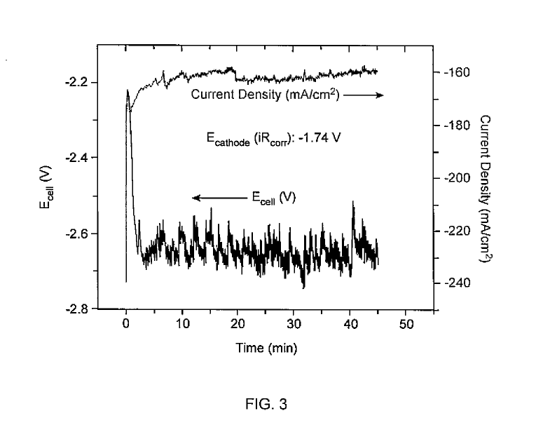

The W-cell electrochemical tests were run in either a semi-continuous or batch mode, depending on whether the flow was engaged. For scalability of the proposed CO₂ conversion process and others under development, a family of continuous-flow electroreactors has been developed, as described in the methods section. This configuration utilizes a central liquid electrolyte channel with a GDE-type electrode on either side. The reactor can be operated in either a two- or three-electrode configuration, with the latter using a reference electrode port installed in the liquid channel. The small form factor of the reactor resulted in hindered performance when gaseous flow fields were used, so all tests were performed without flow fields. FIG. 3 shows representative current density and cell voltage data for the conventional GDE samples housed in the flow reactor using a three electrode configuration. Very high formate selectivities were achieved in these tests; the highest observed selectivity was 88%.

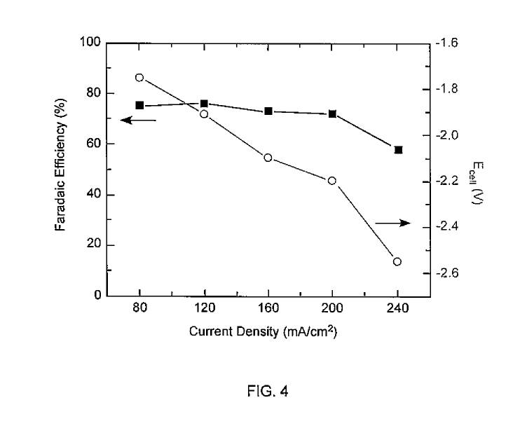

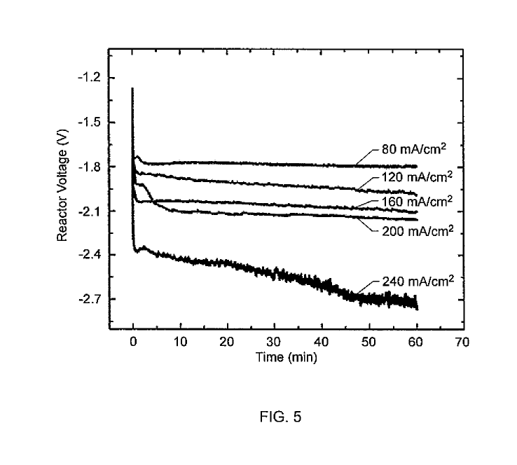

Further testing of the flow reactor was conducted using a two-electrode configuration, which is preferable for industrial-scale installations due to its comparatively simplicity, as long as reactor performance can be maintained in the absence of the additional control afforded by the reference electrode. FIG. 4 shows a plot of the total cell voltage as a function of the applied current density obtained under galvanostatic (current) control, which was found to be more stable than potentiostatic (voltage-controlled) operation. The corresponding selectivity to formate is also included for each data point, obtained from an hour long electrolysis. A selectivity above 70% was maintained up to 200 mA cm⁻², beyond which it began to drop appreciably. FIG. 5 shows the changes in reactor voltage over the course of an hour long electrolysis; i.e. the chronopotentiometry associated with FIG. 4. The instability of the reactor voltage at the highest current density (240 mA cm⁻²) was persistent with repeated trials and is likely the source of lower faradaic efficiency reported in FIG. 4. These preliminary results show several enhancements over the existing literature. Comparison can be made to a 2016 study by Koplijar et al., utilizing the same experimental conditions (Sn catalyst, Pt/H₂ counter, 1 M electrolyte), which reported noticeably inferior performance to that shown in FIG. 5: 80 mA cm⁻² at 2 V potential (relative overpotential of 250 mV) and 140 mA cm⁻² at 2.5 V potential (relative overpotential of ˜500 mV). These improvements are significant and will aid in improving the energy efficiency and hence techno-economics of the eCO₂RR process.

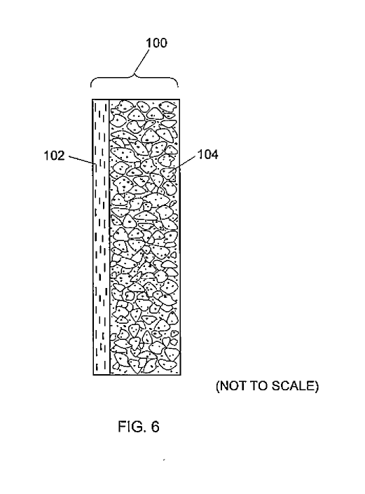

In some embodiments, cathode 100, FIG. 6 includes a mixed hydrophobic/hydrophillc microporous layer 104 deposited onto an essentially hydrophobic gas diffusion layer 102. In one example, layer 102 is a carbon paper substrate coated with a polymer (e.g., Teflon) such that layer 102 is essentially hydrophobic. Layer 104 may include conductive (e.g., carbon) particles bound together with a polymer (e.g. Teflon) and penetrated with an ion conducting polymer (e.g. Nafion) such that layer 104 exhibits a mixed hydrophobic/hydrophilic character. See also U.S. Pat. No. 6,080,504 incorporated herein by this reference. Layer 104 may be high surface area carbon exhibiting mixed hydrophobic/hydrophilic by the incorporation of Teflon and Nafion. Alternatively, layer 104 need not incorporate Nafion and may be still exhibit hydrophobic/hydrophilic character by other means such as plasma discharge to partially oxidize the carbon in layer 104.

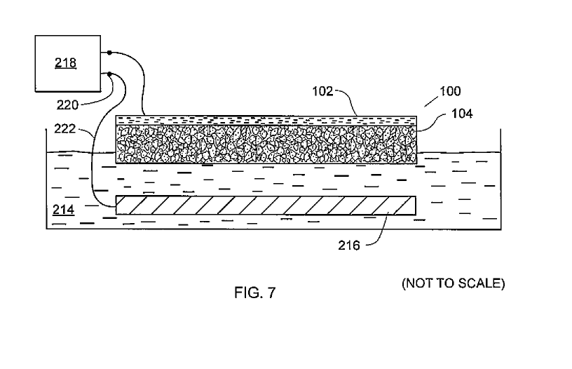

The electrocatalyst is deposited onto layer 104 of gas diffusion cathode 100 by electrodeposition. See U.S. Pat. No. 6,080,504 incorporated herein by this reference. Preferably, as shown in FIG. 7, a CO₂ reduction catalyst (e.g., Pb, Hg, In, Sn, Cd, or Ti) is electrochemically deposited onto microporous layer 104 using a pulse current or pulse reverse current supplied by power supply 218, as previously discussed, passed between gas diffusion cathode 100 and a counter electrode 216 in a bath 214 containing ions of the catalyst. In this way, the nucleation/growth of the catalyst particles are balanced resulting in a more uniform deposition of catalyst particles of predominantly less than 20 nm in size onto the microporous layer 104. In one example, a PC forward only 1.1 Aₚₑₐₖ 0.2 ms on and 9.8 ms off times was used.

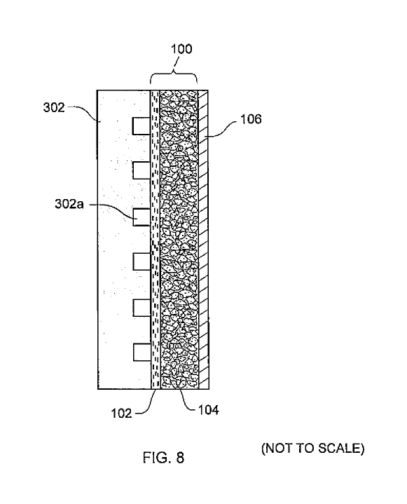

One preferred GDE generally includes a catalyst layer and a gas diffusion zone as the gas diffusion cathode 100, FIG. 8. The gas diffusion cathode 100 in turn may include a macroporous carbon fiber substrate (CFS) 102 with an applied microporous layer (MPL) 104. The CFS may include a carbon paper or cloth substrate rendered hydrophobic by the incorporation of TEFLON®. The MPL may include high surface area carbon rendered with a mixed hydrophobic/hydrophilic character by the incorporation of TEFLON® and NAFION®. The NAFION® may be applied by painting, spraying or floating the gas diffusion cathode of a solution of NAFION® whereby the NAFION® partially penetrates the microporous layer 104 and renders that portion of layer 106 hydrophilic. Care is taken not to allow the NAFION® to penetrate the macroporous gas diffusion layer 102 as this layer should remain essentially hydrophobic. The application procedures of the NAFION® generally result in a thin ionomer layer 106 on the surface of the gas diffusion cathode facing the electrolyte. Conductive plate 302 provides electrical contact from the macroporous carbon fiber substrate 102 side of the gas diffusion electrode 100 to the external circuit. Channel 302a provides a pathway for delivery of the CO2 reactant gas to the macroporous carbon fiber substrate side of the gas diffusion electrode 100.

In the conventional catalyzation process, the catalyst particles are incorporated within the ionomer that is applied to the MPL via painting or spraying leading to a partial ingress of a proton-conducting (typically hydrophilic) ionomer matrix. This mixed hydrophobic/hydrophilic character of the MPL 1) avoids liquid penetration through to the macroporous carbon fiber substrate layer 102 2) facilitating wetting at the electrolyte junction in order to establish a three-phase interface between the gaseous CO₂ reactant and the solid catalyst supported on the electron-conducting carbon and the electrolyte. This three-phase interface concept is derived from fuel cell developments and is generally described by a “flooded agglomerate” model including spheres of ionomer-coated catalyst particles.

In an alternative procedure, the catalyst particle are applied to the high surface are carbon particles prior to their formation into a microporous layer 104 and applied to the macroporous carbon fiber substrate layer 102.

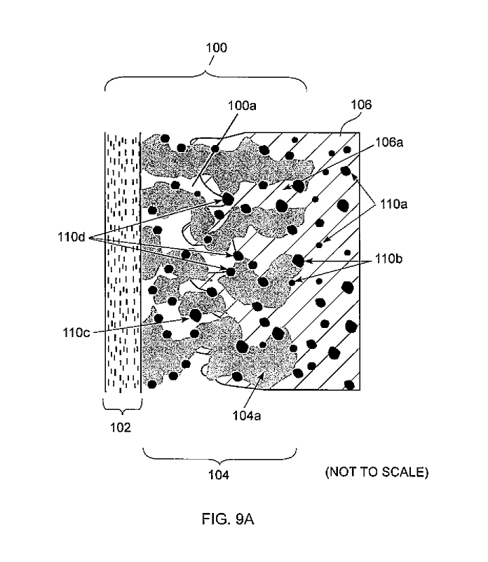

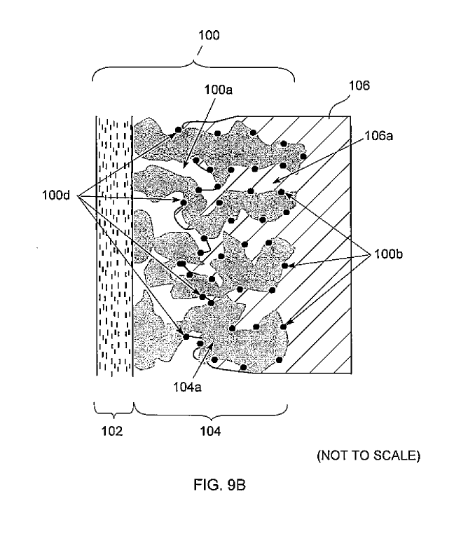

The significance of the pulse/pulse reverse electrocatalyzation process is depicted in FIGS. 9A-9B. For conventional GDEs, the catalyst particles 110a, 110b, 110c—are depicted in FIG. 9A. In the case of application of the catalyst particles by painting or, spraying the ionomer containing the catalyst, the catalyst particles are generally large (i.e. >100 nm) and distributed uniformly through the ionomer matrix. Due to this uniform distribution, some of the catalyst particles 110a are not in contact with the carbon particles 104a of the MPL and consequently are not at the necessary three-phase interface and are not utilized in the electroreduction reaction. Additionally, some of the catalyst particles 110b may be in contact with both the ionomer 106 and the carbon particles of the microporous layer 104, but are not in contact with the reactant gas and consequently are not at the necessary three-phase interface and are not utilized in the electroreduction reaction. In the case of depositing the catalyst particles on the carbon particles and subsequently applying the microporous layer 104 to the macroporous carbon fiber substrate 102 followed by applying the ionomer by spraying, painting or floating, the catalyst particles are uniformly distributed through the microporous layer 104. Consequently, some of the catalyst particles 110b may be in contact with both the ionomer and the carbon particles of the microporous layer 104, but are not in contact with the reactant gas and consequently are not at the necessary three-phase interface and are not utilized in the electroreduction reaction. Additionally, some of the catalyst particles 110c may be in contact with carbon particles 104a of the microporous layer 104 that are not in contact with the ionomer and consequently are not at the necessary three-phase interface and are not utilized in the electroreduction reaction. As a first order estimate assuming the various catalyst particles are equally distributed across the four types of catalyst particles with only catalyst particles 110d positioned in the three-phase zone and consequently utilized, the utilization of the catalyst particles in the prior art is limited to approximately 25%.

In both catalyst application techniques presented above, the catalyst particles are generally non-uniform. Furthermore, in both catalyst application techniques presented above, some catalyst particles 110d are in contact with the ionomer penetrated micropore 106a, the carbon particle 104a and the gas filled micropore 101. The catalyst particles 110d are at the necessary three-phase interface and are consequently used in the electroreduction reaction.

In the case of pulse/pulse reverse electrocatalyzation as shown in FIG. 9B, the catalyst particles 110b and 110d are electrochemically deposited after application of the microporous layer 104 onto the macroporous carbon fiber substrate 102. In this manner, the catalyst particles 110b and 110d are only deposited on the gas diffusion electrode where accessibility exists both to the proton conducting ionomer 106 and to a carbon particle 104a with an electron conducting pathway through the microporous layer 104 to the macroporous carbon fiber substrate. 102. The resulting electrocatalyst particles necessarily consist of catalyst particles 110d residing in the three-phase interface and are thereby utilized in the electroreduction reaction. There are still catalyst particles 110b in contact with both the ionomer and the carbon particles of the microporous layer 104, but are not in contact with the reactant gas and consequently are not at the necessary three-phase interface and are not utilized in the electroreduction reaction. Unlike catalyst particles 110a and 110c of FIG. 9A, in FIG. 9B there are no catalyst particles which are not in the three-phase zone and not utilized. As a first order estimate assuming the various catalyst particles are equally distributed across the two types of catalyst particles with only catalyst particles 110d positioned in the three-phase zone and consequently utilized, the utilization of the catalyst particles in the subject invention is approximately 50%.

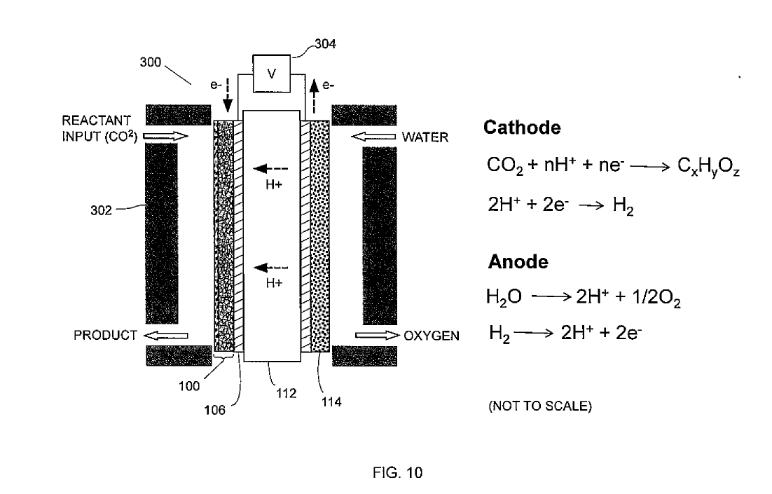

In addition, the catalyst particles of the subject invention are of approximate uniform particle size and less than approximately 50 nm in diameter resulting in a large surface area and thereby high electroreduction activity. Next, the electrocatalyzed gas diffusion cathode 100 may be employed in an electrochemical reactor 300, FIG. 10 along with an anode 114 and voltage source 304 connected to the cathode and the anode to convert CO₂ to another chemical. See also U.S. Pat. No. 9,145,615 incorporated herein by this reference. In some embodiments, the reduction catalyst used is Sn which can be used to convert CO₂ to a formic acid.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. An electrocatalytic CO₂ reduction method comprising:
forming a gas diffusion cathode including a high surface area largely microporous layer on a low surface area gas diffusion layer, whereby the microporous layer is relatively hydrophilic compared to the relatively hydrophobic gas diffusion layer;
electrocatalyzing the gas diffusion cathode by electrochemically depositing a CO₂ reduction catalyst onto the microporous layer using a pulse current or pulse reverse current passed between the gas diffusion cathode and a counter electrode in a bath containing ions of the catalyst to balance nucleation/growth of the catalyst particles resulting in a more uniform deposition of catalyst particles of predominantly less than 50 nm onto the microporous layer; and
employing the electrocatalyzed gas diffusion cathode in an electrochemical reactor along with an anode and voltage source connected to the cathode and anode to convert CO₂ to another chemical.

2. The electrocatalytic CO₂ reduction method of claim 1 in which the reduction catalyst is selected from the group including Pb, Hg, In, Sn, Cd, and Ti.

3. The electrocatalytic CO₂ reduction method of claim 2 in which the other chemical is formic acid.

4. The electrocatalytic CO₂ reduction method of claim 1 in which the reduction catalyst is Sn.

5. The electrocatalytic CO₂ reduction method of claim 1 in which the low surface area gas diffusion layer is carbon paper.

6. The electrocatalytic CO₂ reduction method of claim 1 in which the high surface area largely microporous layer includes conductive particles in a resin binder.

7. The electrocatalytic method of claim 1 where at least 50% of the catalyst particles are utilized for the electrochemical reduction reaction.

8. A method of making a gas diffusion cathode, the method comprising:
applying a microporous layer to a macroporous layer to form a cathode;
subjecting the cathode to an electrocatalyzation process including electrochemically depositing a reduction catalyst onto the microporous layer wherein catalyst particles are in contact with particles of the microporous layer which are in electrical continuity with the macroporous layer.

9. The method of claim 8 in which the macroporous layer is hydrophobic,

10. The method of claim 8 in which the microporous layer is partially hydrophobic and partially hydrophilic,

11. The method of claim 8 in which the macroporous layer includes carbon fiber substrate,

12. The method of claim 8 in which the microporous layer includes high surface area conductive particles and a resin binder,

13. The method of claim 8 in which the reduction catalyst is selected from the group including Pb, Hg, In, Sn, Cd, and Ti.

14. A method of making a gas diffusion cathode, the method comprising:
applying high surface area carbon microporous layer to a macroporous carbon fiber substrate;
subjecting the high surface area carbon microporous layer to an electrocatalyzation process including electrochemically depositing, using a pulse current or pulse reverse current, catalyst particles onto carbon particles of the carbon microporous layer and providing a proton conducting ionomer surface partially penetrating the carbon particles of the carbon microporous layer.

15. The method of claim 14 in which the electrocatalyzation process includes placing the carbon microporous layer in a bath including ions of the catalyst and connecting a power supply to the carbon fiber substrate and a counter electrode in the bath.
